(19) United States
(12) Patent Application Publication
(10) Pub. No.: US 2011/0202909 A1
(43) Pub. Date: Aug. 18, 2011

(54) TIER SPLITTING FOR OCCASIONALLY CONNECTED DISTRIBUTED APPLICATIONS

(75) Inventors: Henricus Johannes Maria Meijer, Mercer Island, WA (US); Dragos Manolescu, Kirkland, WA (US)

(73) Assignee: MICROSOFT CORPORATION, Redmond, WA (US)

(21) Appl. No.: 12/705,437

(22) Filed: Feb. 12, 2010

(51) Int. Cl. G06F 9/45; G06F 15/173; G06F 9/44

(52) U.S. Cl. 717/151; 709/226; 717/167

(57) ABSTRACT

Distributed programming is aided by tier splitting single-tier applications into multi-tier applications. Computations and persistent data are split across tiers to generate offlineable or occasionally connected distributed applications. More specifically, computations are divided amongst tiers while preserving the semantics of a single-tier application, and upstream-tier resident data and changes thereto are replicated downstream to facilitate offline work.

### BACKGROUND

Distributed computing refers to computer processing in which different parts of a program or application are run concurrently on two or more autonomous computers that communicate over a network such as the Internet. These computers interact with each other to achieve a common goal. Work is distributed amongst a number of computers often to accomplish a task that is impossible with the processing power of a single or particular computer. Alternatively, work can be distributed across multiple computers simply to expedite processing.

Various network architectures, models, or the like can be employed to communicatively couple numerous computers and enable distributed computing. One of the most well known architectures is the client-server or two-tier architecture. Here, work is partitioned between servers that act as content or service providers and clients that request content or services provided thereby. Some specific server types include, without limitation, web, application, database, mail, file, and printer servers. Exemplary client types include web browsers and e-mail clients, among others. Other multi-tier architectures are also conventionally employed such as a three-tier architecture that includes a presentation, application (a.k.a. business logic, logic, middle), and data tiers, which separates presentation, application functionality, and data storage and access, respectively. By contrast, a single-tier architecture includes presentation, application, and data in a single location.

Unfortunately, developing distributed applications is a very onerous process. In particular, dissimilar environments need to be taken into account on which portions of a program will execute. For instance, computers likely will have different file systems, operating systems, and hardware components. Further yet, programmers need to have more than a casual understanding of numerous distributed programming technologies (e.g., HyperText Markup Language (HTML), JavaScript, Extended Markup Language (XML), Structured Query Language (SQL), Simple Object Access Protocol (SOAP) . . . ). Still further yet, programmers need to make decisions upfront as to how programs will be partitioned across two or more tiers and are forced to focus on asynchronous callbacks and other time-consuming distributed programming issues, which may prematurely fixate distribution boundaries and negatively affect development of rich and broad reaching distributed applications.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally concerns utilizing tier splitting mechanisms to facilitate development of occasionally connected distributed applications. A tier splitter transforms single-tier applications into multi-tier applications (e.g., two tier, three tier . . . ) by splitting computations across tiers, for example at compile time as a function of execution context/runtime environment, among other things. Consequently, programmers can initially develop a single-tier or tier-independent application that can subsequently be split across tiers as a function of a particular execution context, for example. Such computation tier splitting, however, can involve moving data associated with the computation from a first tier (e.g., client) to second tier (e.g., server), for instance, to aid execution. Alternatively, the associated data can reside on the second tier prior to splitting. In any event, the data is not local to the first tier, thus substantially limiting or prohibiting offline work thereon. In response, data tier splitting can be employed to replicate second-tier data to the first tier. Stated differently, computation and data can be tier split to enable generation of occasionally connected distributed applications. A variety of other functionality is also disclosed relating to maintaining consistency across multiple tiers and optimization, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a representative tier-splitter system.

FIG. 2 is an illustration of computation tier splitting.

FIG. 3 is an illustration of computation and data tier splitting.

FIG. 4 is a block diagram of a representative tier-splitter system.

FIG. 5 depicts an exemplary offlineable distributed application split across two tiers.

FIG. 6 is a block diagram of a sample-operating environment for a tier-splitter system.

FIG. 7 is a block diagram of a sample-operating environment for a tier-splitter system.

FIG. 8 is a flow chart diagram of a method of facilitating computer application development.

FIG. 9 is a flow chart diagram of a method of generating an occasionally connected distributed application.

FIG. 10 is a flow chart diagram of a method of operation on a tier.

FIG. 11 is a flow chart diagram of a method of operation on a tier.

FIG. 12 is a flow chart diagram of a method of operation on a tier.

FIG. 13 is a schematic block diagram illustrating a suitable operating environment for aspects of the subject disclosure.

### DETAILED DESCRIPTION

Details below are generally directed toward various aspects of tier splitting for occasionally connected distributed applications. Distributed application development is aided by a tier splitter mechanism that splits both computation and persistent data across multiple tiers. Initially, applications need only be developed as single tier or tier independent applications, which can subsequently be split or sliced into multiple tiers at or around compile time, for example, by a computation tier splitter. As a result, programmers are not forced to make premature decisions as to how computation should be split and are relieved of many difficulties related to distributed-programming. Nevertheless, the computation tier splitter can also move data associated with one or more computations or alternatively the data can be stored on a separate tier. Without local data access, offline work is severely limited if at all possible. A data tier-splitter mechanism replicates moved or otherwise unavailable data as well as changes thereto to a client, for instance, to enable offline work, among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

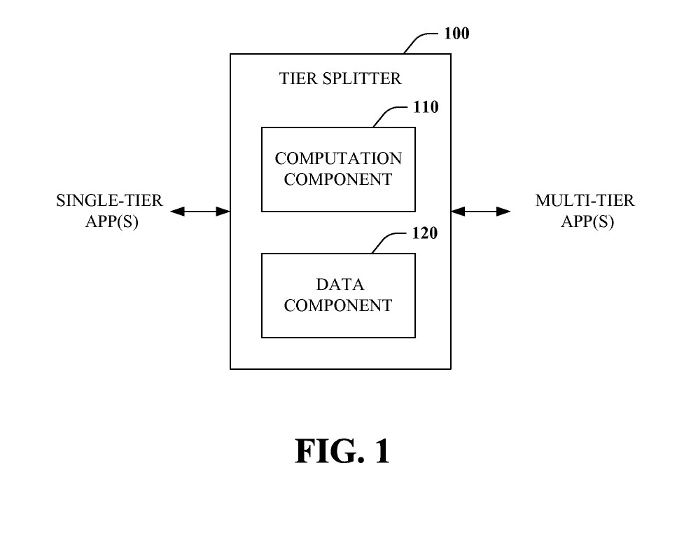

Referring initially to FIG. 1, a representative tier-splitter system 100 is illustrated that facilitates generation of occasionally connected applications. As shown, the tier-splitter system 100 receives, retrieves, identifies, or otherwise obtains or acquires one or more single-tier or tier-independent applications and outputs one or more multi-tier applications. Moreover, the one or more output multi-tier applications can be occasionally connected applications (a.k.a. offlineable applications), which are designed to operate even when communication between tiers is unavailable, rather than fail or completely halt operation until communication is reestablished. Generation of a multi-tier application can be accomplished by automatically or semi-automatically re-writing a single-tier application or generating a new multi-tier application based on the single-tier application including all program code to support cross-tier interaction at or around compile time, for example. Consequently, the tier-splitter system 100 substantially mitigates programmer burden by providing a mechanism to aid production of an occasionally connected distributed application from a tier-independent application. As a result, a developer can focus on developing rich and broad reaching applications that might not otherwise be possible if the developer is burdened with complexities and details of distributed and occasionally connected programming.

The tier-splitter system 100 includes a computation component 110 and a data component 120. The computation component 110 splits single-tier computation across two or more tiers while preserving the semantics of the single-tier application. In other words, given an input, a multi-tier application produces the same result as a corresponding single-tier application from which the multi-tier application was generated. A variety of code can be injected at or around compile time, for example, to effect such functionality automatically or semi-automatically (e.g., guided by single-tier programmer specified code annotations). For example, computation including but not limited to functions, methods, and services can be transformed from synchronous to asynchronous, utilizing co-routines or other continuation constructs, which are a generalization of subroutines that allow multiple entry points and can be suspended and resumed at particular code locations. Other code can be inserted relating to state preservation and/or communication across tiers.

In accordance with one embodiment, one or more pre-split libraries or the like can be employed by the computation component 110 to facilitate transformation of the code into distributed code executable across multiple tier architectures. Such libraries can resemble conventional base class and/or GUI (Graphical User Interface) libraries, for example, that provide inherent support for multi-tier architectures. Accordingly, developers can program without explicitly specifying support for distributed processing. For instance, application programming interfaces (APIs) exposed to the programmer and the manner of calling them need not be different for standard and pre-split libraries.

The data component 120 propagates tier persistent data and changes to or effects on the data from a first tier to a second tier, wherein persistent data represents data that survives startup and termination of application sessions as opposed to transient data, which is discarded after application termination. In a two-tier architecture where data is moved from a client to a server during computation splitting, a copy of the data can be propagated back from the server to the client. In computer networking the terms upstream and downstream are often used to represent sending or in other words movement away from a client (upstream) and receiving or in other words movement toward a client (downstream). Of course, the terms upstream and downstream are not limited to a client-server relationship, but are described as such to aid understanding. Similar terminology can also be employed here to describe movement of data across tiers. By way of example and not limitation, persistent data moved to a server with one or more computations, or that is initially stored on the server without regard to computation splitting, can be termed upstream persistent data, while data propagated back to the client can be said to be pushed, or transmitted, downstream. In accordance with one embodiment, known or novel synchronization mechanisms or frameworks can be exploited to implement the data component 120.

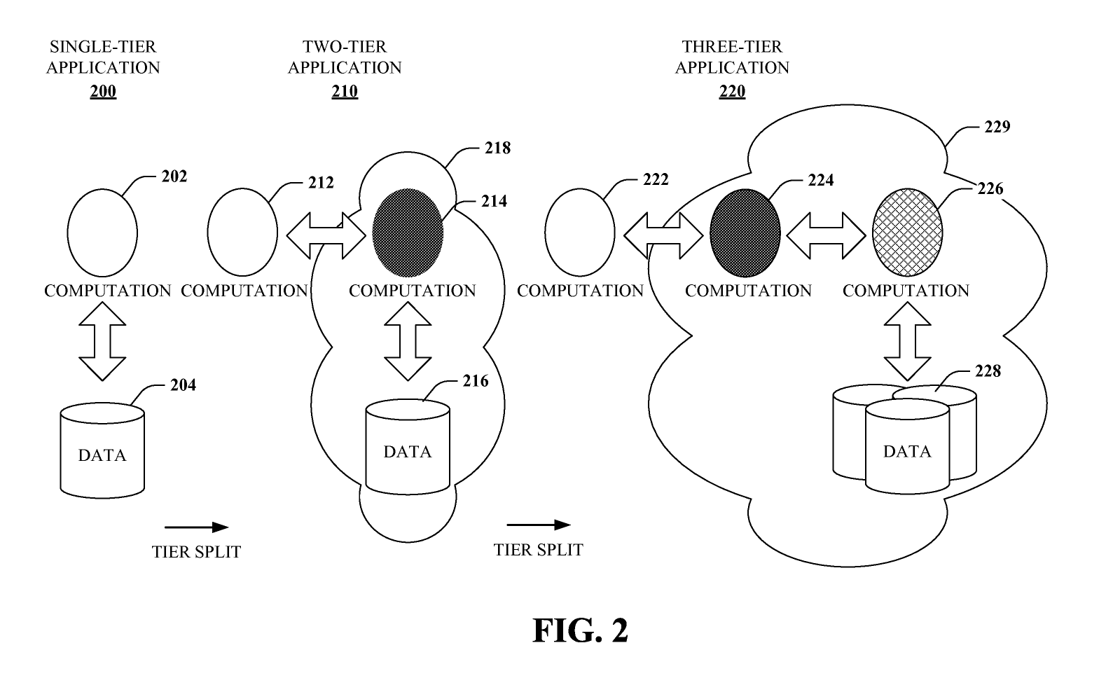

FIG. 2 is an illustration of computation tier splitting to facilitate clarity and understanding with respect thereto. As depicted, a single-tier application 200 is tier split into a two-tier application 210 that can be split into a three-tier application 220 by tier-splitter system 100 of FIG. 1. In accordance with one embodiment, tier splitting can be applied recursively or alternatively successively such that single-tier application 200 is split into two pieces to generate a two-tier application 210 and one tier of the two tier application 210 can be split into two pieces to form three-tier application 220. Of course, splitting is not limited thereto. By way of example and not limitation, the single-tier application 210 can be split in a single splitting operation into the three-tier application.

The ovals 202, 212, 214, 222, 224 and 226 of FIG. 2 generally correspond to computations (e.g., computer executable code, functions, methods . . . ), and the cylinders 204, 216, and 228 represent databases or persistent data. More abstractly, one can think of the ovals 202, 212, 214, 222, 224 and 226 as verbs (e.g., compute discount, add to shopping cart, compute total price, calculate shipping cost . . . ) and the cylinders 204, 216, and 228 as nouns (e.g., customer, order, item . . . ).

The single-tier application 200 includes one or more computations 202 and associated persistent data 204. This is a simplified representation of an original application identifying intended semantics specified by a programmer Note also that the single-tier application 200 can include transient data with various other sources of data that may or may not be persistent, wherein transient data is created within an application session and discarded at the end of the session. One benefit associated with single-tier application 200 is that the computations 202 have local access to data 204.

The two-tier application 210 is a tier split version of single-tier application 200 wherein computations 202 are split across the two tiers, namely computations 212 and 214. In this exemplary non-limiting scenario, computations 214 are stored in a cloud 218, wherein the cloud 218 refers to a communication network such as the Internet and underlying network infrastructure. For instance, computations 212 can be stored and executed on a client computer device (e.g., mobile phone, personal computer, set-top box . . . ) and computations 214 can be stored and executed on a network-connected server. Moreover, persistent data 204 is also moved with computation and is now stored in database 216 local to the computations 214. In other words, reference data or data utilized by the computations 214 is moved upstream, or away from a client, with the computations 214. Computations 214 can then be performed on the data 216 potentially changing the data 216 (e.g., add, delete, modify . . . ) and any results associated with the computations 214 returned downstream to the client. In one embodiment, computations 212 and 214 are asynchronous. As a result, results of one or more of the computations 214 can by returned downstream to the client (e.g., asynchronous callback). Further, the client can perform computations 212 at substantially the same time (e.g., in parallel) and can subsequently incorporate any returned results.

By way of example and not limitation, consider an application that processes large-scale video data. A single client computer might not be able to perform certain computations. Accordingly, the application can be split across two-tiers such that a more powerful server can perform the computations that the client cannot. Further, this can involve relocating the video data upstream and local to the computations that will act thereon. Alternatively, it is to be appreciated that the video might already reside upstream from the client on shared database, for instance.

The three-tier application 220 includes an additional split. Originally specified computations 202 are split into computations 222, 224, and 226. Alternatively, it can also be said that computations 212 remains the same as computations 222 and computations 214 are divided into computations 224 and 226. Computations 222 can be carried out by a client, computations 224 can be executed by a middle tier service, and computations 226 can be performed by a back-end data tier, wherein computations 224 and 226 are stored and execute in cloud 229. Again, reference data such as data 228 moves with the computation to the data tier.

Computational tier splitting alone reveals several significant features with respect to production of occasionally connected or offlineable distributed applications. First, like a conventional single-tier application, there is an assumption that each tier is online and able to communicate at anytime. Stated differently, there is no consideration for network latency including infinite latency (e.g., offline) and errors, among other things. Second, persistent data is pushed or originates upstream. While this is beneficial upstream in that local data makes access quite simple, it also limits the ability to work offline on a downstream tier (e.g., client) if possible at all. However, these issues can be addressed by tier splitting data as well and more specifically reverse tier splitting persistent data.

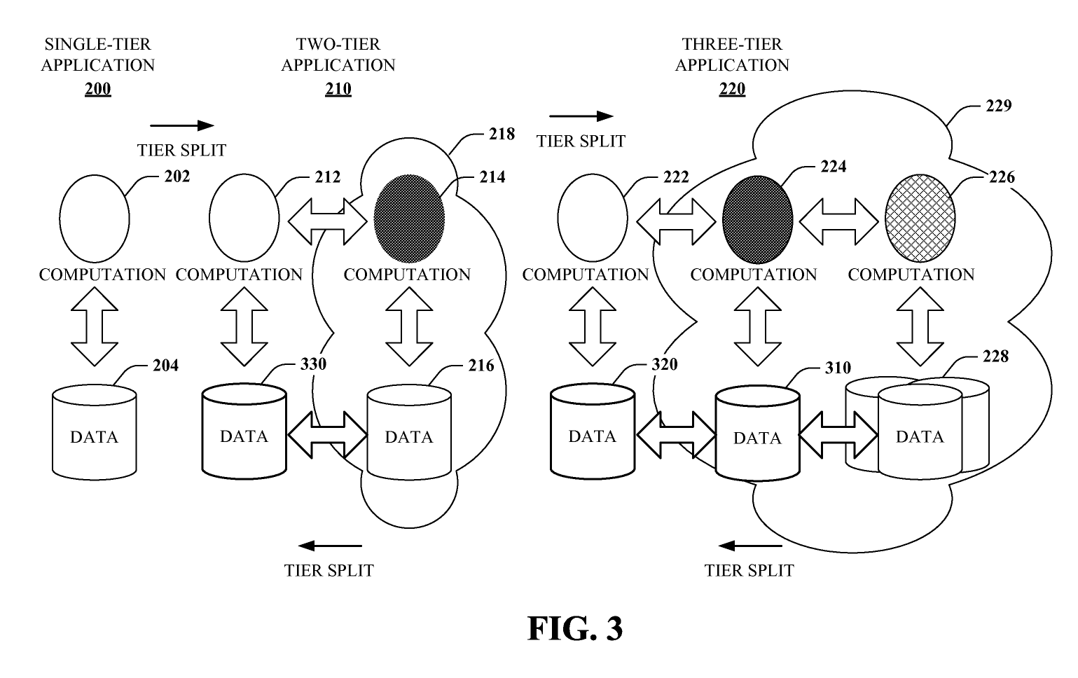

Turning attention to FIG. 3, an illustration of computation and data tier splitting is provided to facilitate clarity and understanding. FIG. 3 is substantially similar to FIG. 2 in that includes the same tiers, namely the single-tier application 200, two-tier application 210, and three-tier application 220 including computations 202, 212, 214, 222, 224, and 226 as well as persistent data 204, 216, and 228. However, FIG. 3 also depicts data being tier split with respect to the two and three tier applications, 210 and 220, respectively. This can be referred to as reverse tier splitting, or more specifically reverse data tier splitting, since it generally goes in the opposite direction with respect to computation tier splitting in which computations as well as reference data are pushed upstream or away from a client. As per data tier splitting, however, data is pushed downstream or to or toward a client. More specifically, upstream data including changes made by upstream computations are propagated downstream, for example by replication.

As shown in FIG. 3, the database 228 is replicated downstream to form database 310, which can then be replicated to form database 320 with respect to three-tier application 220. Further, the database 216 can be replicated to form database 330 in the two-tier application 210. By pushing data downstream to a client or other computer, the client or other computer can include a local copy of data on which it can work offline, for instance. In this manner, an application can leverage resources such as but not limited to cloud resources while also including an offline capability. This technology can thus assist in development of a plethora of distributed applications, including cloud-based applications or services (e.g., software as a service (SaaS), utility computing, web services, platform as a service (PaaS) . . . ) and mobile applications that operate in an occasionally connected environment.

Amongst many solutions for database replication, as described above, known or novel synchronization mechanisms or frameworks can be employed in accordance with one embodiment. In other words, upstream data can be synchronized to downstream stores. In this context and in accordance with one embodiment, thousands of shapes and forms of data can be manipulated with four operators, namely create, read, update, and delete—CRUD operators. Accordingly, CRUD-enabled data structures can be generated, maintained, and synchronized. Tier splitting of data can thus be described in terms of tier splitting CRUD operations. Among other things, this serves to indicate that nothing significant is happening with respect to particular data except synchronization. It is more about the shape of the data than the data itself. Of course, this is only one way to implement aspects of the claimed subject matter and it is not intended that the claims be limited thereto.

Regardless of the techniques, technologies, or means of implementing both computation and data tier splitting, a tier-split application should be consistent. Otherwise, the application may not function properly. To aid understanding, consider the two-tier application 210 shown in FIG. 3. At a high level, the ovals, cylinders, and arrows from a square that should commute. In other words, the challenge is to make the square have the same effect in view of work performed offline or in other words, when cross-tier communication is unavailable. For example, imagine the application 210 is offline such that both horizontal links (represented by horizontal arrows) are broken or otherwise unavailable. Now, the only thing that can be done is some computations 212 with respect to local database 330. When the horizontal links come back, the database 216 is updated in an exemplary embodiment to reflect any changes made to the database 330. In accordance with one embodiment, such changes can be made by making a call from computation 212 to computation 214 to update the database 216. Additionally, changes could have been made to the database 216 while offline that should be propagated to database 330. Accordingly, the state on top (e.g., computations 212 and 214) should reconcile with the state on the bottom (e.g., databases 216 and 230). Stated differently, everything done with respect to the left computation 212 and database 330 should commute with everything done with respect to the right computation 214 and database 216. State should reconcile regardless of the order of state changes with respect to left computation 212 and database 330, and computation 214 and database 216. This can be tractable with at least a combination of operation queuing and abstract computation described in further detail below.

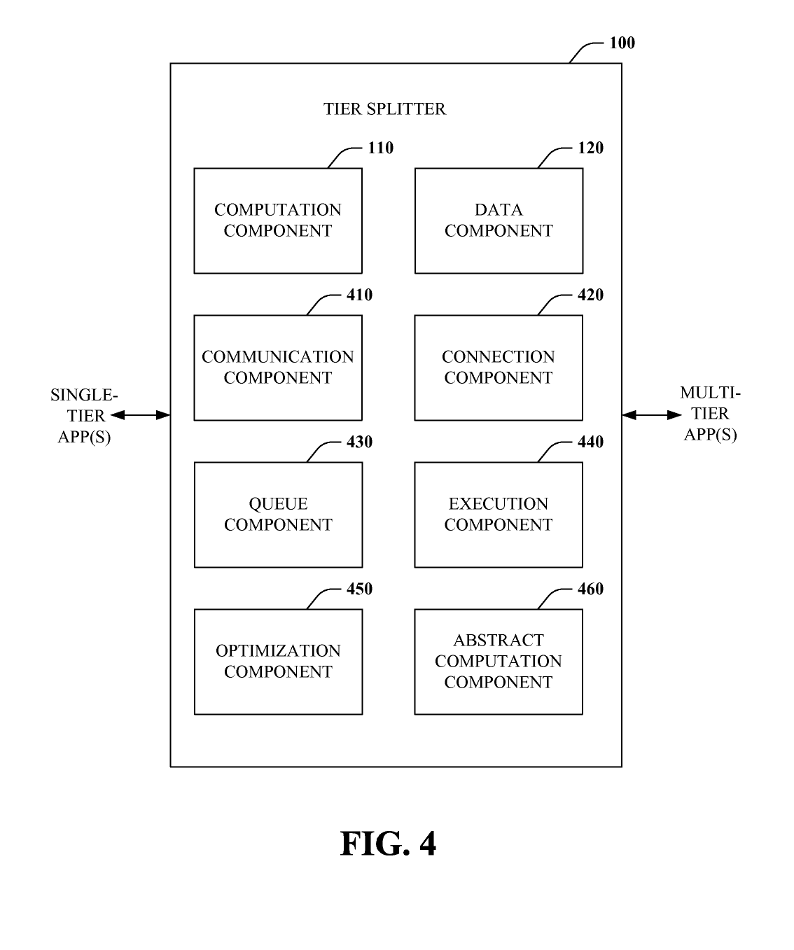

Referring to FIG. 4, a representative tier-splitter system 100 is depicted. Similar to FIG. 1, the tier-splitter system 100 receives, retrieves, or otherwise obtains or acquires one or more single-tier applications and outputs or otherwise make available for retrieval one or more multi-tier applications. More specifically, the tier-splitter system 100 includes a plurality of components for modifying a single-tier or tier-independent application to produce an offlineable multi-tier application or alternatively for generating an offlineable multi-tier application based on a single-tier application. In accordance with one aspect, the plurality of components can be embodied as program code writer/re-writer components. In one instance, the writer/re-writer components can alter, add, insert, or inject program code or functionality to cause some action or result. For purposes of simplicity only, each component will be discussed below with respect to production of a two-tier or client-server distributed application. Of course, the claimed subject matter is not limited thereto as these same components can be employed recursively, for example, to produce N-tier applications.

Computation component 110 can split code across multiple tiers as described above, for example as a function of execution context and/or user specification, among other things. In one particular embodiment, the computation component 110 can generate functions, methods or the like for execution on one or both of a client and a server. For example, if the server exposes a function void F( . . . , A a, . . . ) on a class C then a class F with a constructor F( . . . , A a, . . . ) to represent that function and an evaluation function void Execute (C target) that performs target.F( . . . , a, . . . ) can be constructed. Effectively, a call to method F is divided into two steps to allow work offline. Stated differently, a data structure is first created that represents the method call as data, and second the data structure that represents the method call is executed thereby effectively executing the original call such that F(a)=execute(new F(a)). Accordingly, computation can be executed locally or passed to the server for execution. Of course, in some scenarios a client might not be able to execute certain computations.

Data component 120, as described further above, can employ data synchronization or the like to cause persistent data to be replicated across multiple tiers. In accordance with one embodiment, the data component 120 can inject synchronization code on server client and/or server, for example, to synchronize data across tiers. Additionally or alternatively, synchronization mechanisms or frameworks known in the art can be employed by the data component 120 to synchronize or replicate data across tiers, for example via calls to an external service or facility. In any event, the data component 120 can cause persistent data to be positioned to facilitate offline computation.

Communication component 410 inserts code on client and server sides to support cross-tier communication. For example, serialization and de-serialization functionality can be provided. In this manner, a client can serialize, CRUD operations and data, for example and transmit them to a server that can subsequently de-serialize the operations and data and perform requested computations. Similarly, the server can serialize a result that can be passed back to the client and de-serialized. In one instance, the communication functionality can be viewed as inserting client and server proxies. Of course, the proxies can include additional functionality including at least functionality associated with the following components.

Connection component 420 generates code associated with online and offline functionality or in other words cross-tier communication state (e.g., available/unavailable, active/inactive . . . ). More specifically, the code can detect or otherwise determine whether or not a multi-tier application online and govern action based thereon. On the client side, for example, operations can be queued if offline or transmitted to the server if online. On the server side, replication or synchronization can be initiated if an active communicative link exists between client and server, or when it is online.

Queue component 430 injects code for managing a client-side queue of one or more actions designated for remote (e.g., server) rather than local (e.g., client) tier execution by way of computation invocation. Such actions can also be referred to herein simply as computation innovations or calls. When a computation needs to be performed by the server and a communication link is broken or otherwise unavailable (offline), a call to, or invocation of, the computation can be added to the queue. When the communication link becomes available (online), the queue can be flushed to the server. Alternately stated, the queue's contents can be transmitted to the server and removed from the queue after transmission.

Conditions or policies can also be imposed for flushing a queue or in other words transferring queue contents to a server and subsequently or concurrently removing the contents from the queue. For example, the queue can be flushed to a server after a predetermined period of time or after the queue reaches a certain size. Such values can be selected to ensure that local and remote states can be reconciled without error. More particularly, these values can be selected to reflect, for example, that extended periods of time between flushes to the server and/or large queue size provide more opportunity for conflicts that may or may not be resolvable. Additionally or alternatively, a priority queue can be employed wherein the nature of an action or priority (e.g., critical, high importance, low importance . . . ) can be considered with respect to queue flushing, among other things. For instance, if an action is non-critical and other conditions are not met then the action can be added to the queue. By contrast, if an action is determined to be of high priority then it can be transferred right away with or without flushing of any other queued actions to the server. In another exemplary policy, a ring buffer can be utilized that transmits and discards old values once it is full, keeping only the most recent values. Overall, however, actions can be batched and deferred since transmission is expensive at least in terms of at least latency and use of network bandwidth.

An upstream computer such as a server can also initiate queue flushing. A server's state can change for various reasons. For example, some data might arrive or be pushed thereto. Accordingly, the server can notify the client that queued operations should be transmitted since something is happening on the server side. By way of example, where an application concerns expense reports, upon reaching the end of the month the server can request expense reports be pushed from the client to the server so that client reports can be synchronized to the server.

In one particular embodiment, actions can initially be added to the queue regardless of online or offline state with respect to tier connectivity. Even if a tier split application is online, actions can be added to the queue and later synchronized or pushed to the server. In addition to being a simpler model, this embodiment can leverage queue optimization and abstract computation as will be discussed further below. An additional benefit can be realized with respect network latency and bandwidth utilization by continually grouping actions and processing groups of actions (e.g., batch processing).

Execution component 440 produces code to facilitate server-side execution of actions. More specifically, upon receipt of a collection or set of actions for server evaluation, the code can ensure that each action is executed. Such code is particularly useful when a client-side queue is flushed and a set of actions, representing queue content, are communicated to the server.

Optimization component 450 can insert functionality that optimizes a queue. Even if a client is not able to perform any of the actions included within the queue, it can reason about actions at least at the level of combinations. For instance, some algebra can be applied to potentially reduce the number actions that need to be transmitted to and ultimately executed by the server. By way of example, if a first action adds something and another action removes that same something, it is the same as doing nothing. Similarly, if two actions change a value, a single action can be produced that effects the change of the two actions. Further, if one action changes something and another deletes it, this is the same as simply deleting it. Accordingly, when offline, a client can optimize a queue by combining or removing redundancy.

In another illustrative example of queue optimization, consider multiplication by zero. If two numbers need to be multiplied and one of them is zero that is the same as not multiplying at all since the result will be zero. Similarly, if a plurality of numbers is being queued to be multiplied, as soon as a zero is pushed to the queue, everything else can be removed because the result is known to be zero. In another instance, if two of the same numbers are to be multiplied, then the square of the number can be substituted. Again, even though nothing is being executed yet in the queuing process, it can still be optimized. As a result, less work can be sent from the client to the server once cross-tier communication is available.

Additionally or alternatively, the optimization component 450 can insert functionality on one or more tiers to allow actions than cannot be executed initially by a client to be executed by the client via translation or other transformation, for instance. In other words, actions can be translated from a first form to a second semantically equivalent form to enable local computation. By way of example and not limitation, if a server sends PostScript and a client cannot interpret that code then it can be translated into PCL (Printer Control Language) code and sent to the client.

Abstract computation component 460 injects functionality to perform abstract computations with respect to server actions. In other words, a subset of actions can be performed on an abstraction of the server on the client side. By way of example, suppose an application seeks to multiply two numbers together, but the client is unable to perform the multiplication. When offline, this multiplication operation can be queued. Now suppose, in a user interface (UI) the result of the multiplication is to be colored red if it is negative and green if it is positive. The client need not be able to perform the multiplication to determine whether the result of the multiplication will be positive or negative. If both numbers are positive or if both numbers are negative, the result is positive. Alternatively, if one of the numbers is positive and another is negative, the result is negative. As a result, this part can be computed on the client even though the client does not have an actual result. In any event, the computation should be proper or in other words, it is a proper abstraction meaning that the part of the computation performed on the client will be consistent with the result when it is actually executed on the server. Stated differently, nothing performed on the client will have to be retracted. In the above example, sign computation is a proper abstraction of multiplication. Another example is compositing images when rendering HTML (HyperText Markup Language). Here, a client can draw a bounding box and skip rendering an image that only a server can render.

Many queue optimizations as described above can also be termed abstract computations. Accordingly, queue optimization is one application of abstract computation that is specifically called out herein. However, other computations may not necessarily pertain directly to queue optimization such as the example given above with respect to sign computation. In any event, the concept of abstraction pertains to moving some projection or abstraction of the one tier to the other. In the case of computations discussed above, even though a client cannot perform all actions of a server, there are things that can be done. In particular, the client can perform some computations, and the client can reason about queued operations at the level of combinations, for instance.

Returning back briefly to data component 120, when data is replicated or synchronized, changes made to the data on the server side can be termed a superset of changes to the data on the client. Accordingly, synchronization can occur safely without any inconsistencies. In other words, if everything done on the client is an abstraction (e.g., a reduced or simplified version) of what is done on the server, server computations can be performed safely, and data can be propagated back to the client. Further, since the effects of server computations are a superset of the effects of client computations, synchronization need only be performed from the server to the client. However, it is also safe to go from the client to the server for the same reason since the effects on the server will subsume the effects on the client.

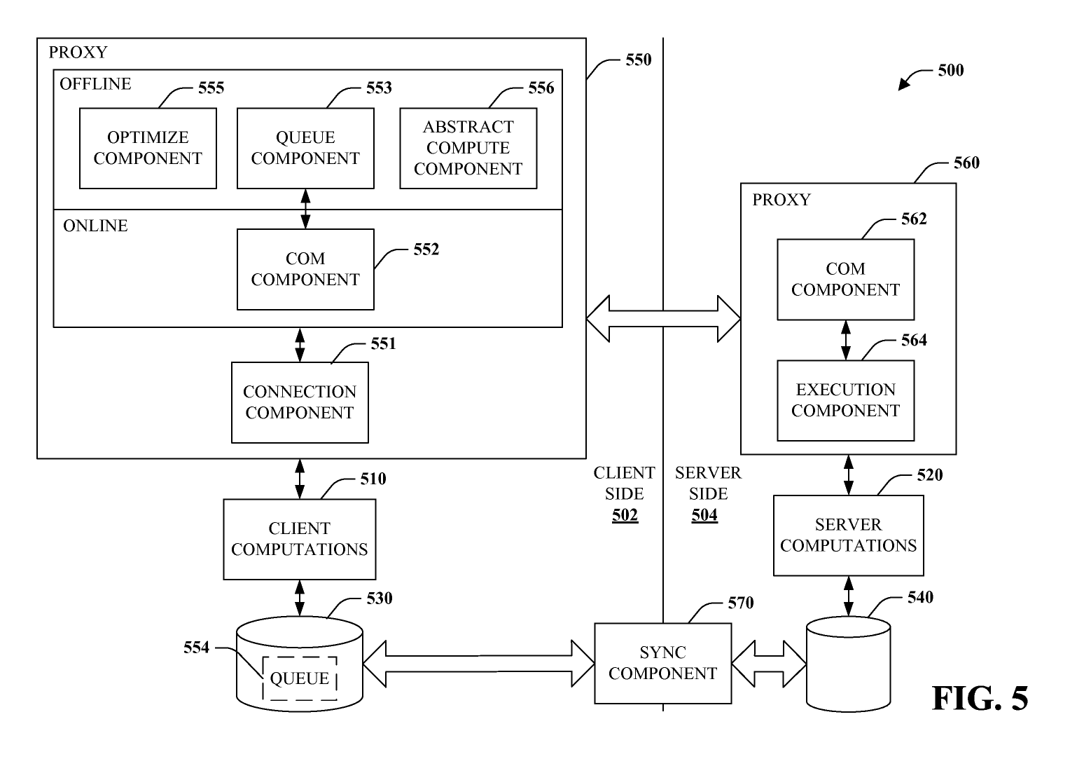

FIG. 5 depicts an exemplary occasionally connected/offlineable distributed application 500 split across two tiers, client 502 (a.k.a. client side) and server 504 (a.k.a. server side). In accordance with one embodiment, the application 500 is generated automatically or semi-automatically by the tier-splitter system 100, described above. As shown, an application's computations (e.g., functions, methods . . . ) are split and are shown in components 510 for the client and 520 for the server. Each tier also includes a respective database, for example, client tier 502 includes database 530 and server tier 504 includes database 540 as shown. Further, client-side proxy 550 and server-side proxy 560 are included and communicatively coupled. Still further yet, a synchronization component 570 can be located on either, both, or neither client tier 502 and 504 and thus is depicted spanning both client and server tiers.

The client-side proxy 550 is linked to the client computations 510 and enables communication with the server 504 as well as offline capabilities. Whenever a client computation requires a call to the server, proxy 550 can facilitate transmission of an action, computation innovation, or the like to the server and return of a result. The client-side proxy 550 can include a connection component 551 that detects a current communication state of the distributed application 500. For example, it can determine that a communication link is currently available between the client and the server (online) or if the communication link is unavailable (offline) for some reason.

Different actions can be taken based on the communication state of the distributed application 500. If the state is online, meaning the client 502 is able to communicate with the server 504, actions can be provided to the communication component 552, which can take an action or the like and related arguments, serialize them, and send them across a communication framework (e.g., wired, and/or wireless, Internet, Local Area Network (LAN) . . . ) to the server. Subsequently, communication component 552 can receive a result from the server, for example as a method or function callback, de-serialize the result, and return it to the caller. Alternatively, if the state is currently offline, meaning the client 502 is unable to communicate with the server 504, queue component 553 receives actions and adds them to a queue 554, which in one embodiment can reside in database or data store 530 as depicted. Although not necessary, storing the queue 554 to non-volatile storage can ensure that even if power is lost the actions will not be lost as well. The queue component 553 can provide management functions with respect to the queue 554 including deciding when to push the contents of the queue to the server. In accordance with one aspect, the queue component 553 can push or otherwise pass the contents or a reference thereto to communication component 552 when a communication link is active or the state is online. In other aspects, one or more conditions or policies can dictate if and when queue content is sent to the communication component 552. While in the offline state, optimization component 555 can seek to optimize the queue, for example by combining actions and removing redundant actions. Furthermore, abstract computation component 556 can execute actions on an abstraction of the server and return results to client actions 510 for further processing.

Turning to the server side, the proxy 560 includes a communication component 562 which similar to communication component 552 on the client side can serialize and de-serialize data provided thereto. In one instance, CRUD operators can be provided to the communication component 562 from the client 502, and the server 504 can serialize and send back any computation results associated with a called operator. Execution component 564, among other things, can receive collections of operations or actions and facilitate execution thereof on the server. Again, results can be obtained and sent back to the client via communication component 562.

Furthermore, synchronization component 570 can synchronize contents of the server database 540 with contents of the client database 530. In one embodiment, the synchronization component 570 can be a known or novel generic synchronization mechanism or framework. Furthermore, the synchronization component 570 need only synchronize in one direction from the server 504 to the client 502, wherein operations performed on the client 502 are a subset or abstraction of operations performed on the server.

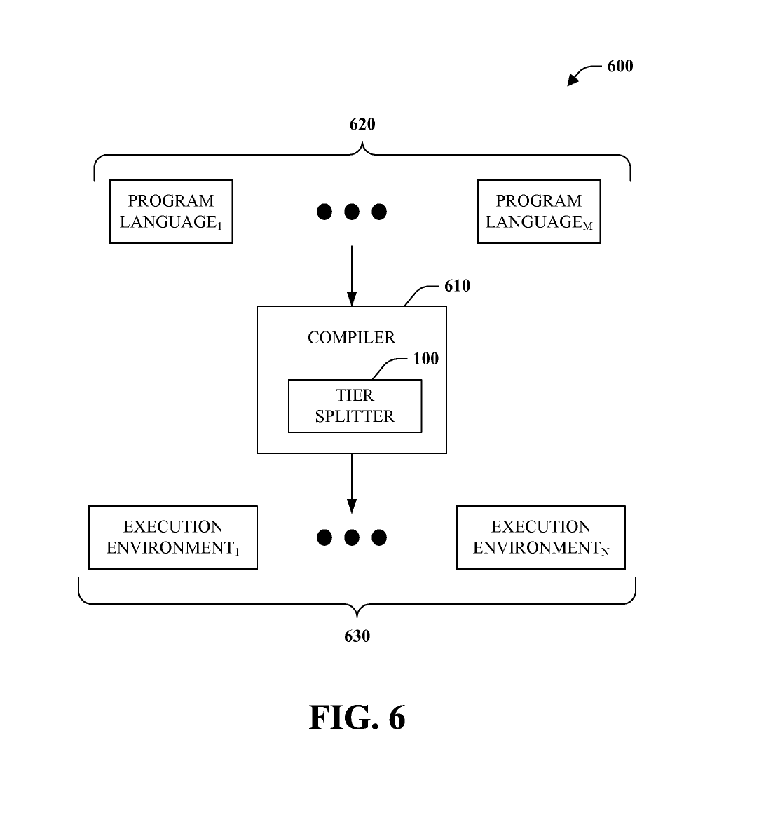

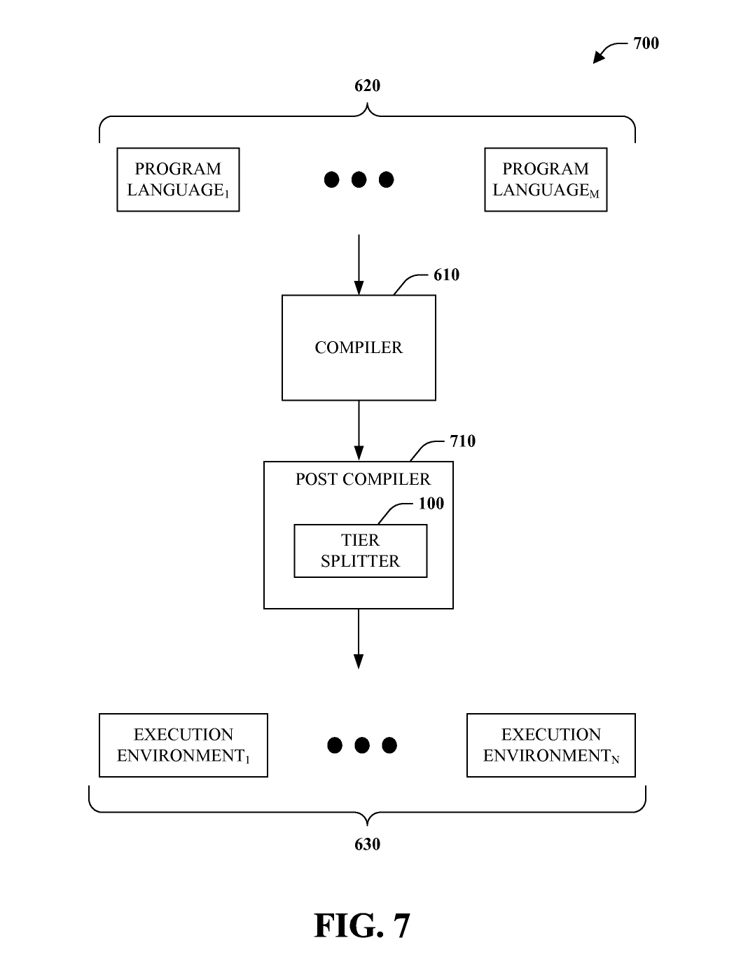

FIGS. 6 and 7 provide sample-operating environments 600 and 700, respectively, for the tier-splitter system 100. Turning first to FIG. 6, operating environment 600 shows the tier-splitter system 100 as a component or sub-system in a compiler 610. A program or application specified in a programming language 620 can be compiled or transformed by compiler 610 to target an execution environment 630. The tier-splitter system 100 can operate during compilation to tier split computation and persistent data across two or more tiers as described in detail herein. In accordance with one aspect, the compiler 610 (which can be a component as defined herein) can operate over a plurality of programming languages (PROGRAMMING LANGUAGE₁—PROGRAMMING LANGUAGE_{M}, where M is an integer greater than one). For example, applications can be specified in Java®, C#®, Visual Basic®, among others. Furthermore, the compiler 610 can target multiple execution environments (EXECUTION ENVIRONMENT₁—EXECUTION ENVIRONMENT_{N}, where N is an integer greater than one) including but not limited to a web browser, virtual machine, and x86 machine. In accordance with one embodiment, the compiler can generate intermediate language (IL) code common to the one or more programming languages 620. The IL code can subsequently be interpreted, complied, or otherwise transformed to execute on one or more execution environments 630.

FIG. 7 is similar to FIG. 6, as described above, provides a slightly different sample-operating environment 700 for employing a tier-splitter system 100. As also provided and described in environment 600 of FIG. 6, environment compiler 610 can compile applications specified in multiple programming languages 620 and target a plurality of execution environments 630. However, rather than forming part of the compiler 610, the tier splitter system 100 can form all or part of a post compiler 710, which operates on compiled code. Accordingly, compiled code such as IL code can be tier split. In this case, conventional compilers need not be modified. Rather, their output can be transformed to produce the same results.

Regardless of whether tier splitting is performed during compilation or after, the result is that a tier-split application can easily target and run on many different machines and/or execution environments 630 since IL code can be deployed on numerous machines and/or environments. For example, a client portion can target a particular machine (e.g., personal computer, mobile phone . . . ) or a web browser while a server portion can target a server execution environment. Furthermore, the compiler 610 and/or or post compiler 710 can consider various code annotations added by a programmer, for instance, to govern how an application is split. Accordingly, tier splitting can be performed automatically with programmer direction or semi-automatically.

Although the tier-splitter system 100 can be incorporated into a compiler or post-compiler, other embodiments are also possible and contemplated. By way of example and not limitation, the tier-splitter system 100 can form part of a developer toolkit or an integrated set of software utilities or tools to facilitate development of applications, among other things. Further yet, the tier-splitter system 100 can be segmented so as to allow an option of generating connected applications or occasionally connected applications. For example, reverse tier splitting of persistent data can be activated or de-activated thereby resulting in production of an occasionally connected or connected application, respectively

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the tier splitter system 100 can employ or inject such mechanisms with respect to determining or inferring an optimal time to flush a queue to a remote tier and/or synchronize persistent data.

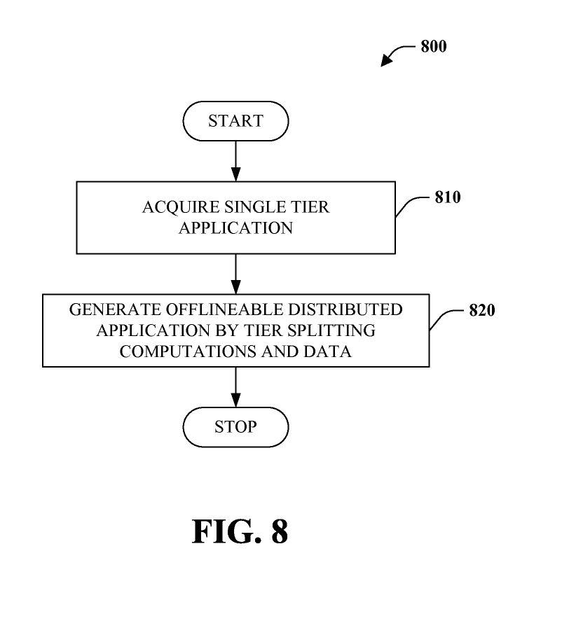

In view of the exemplary systems described supra, methodologies that may be implemented in accordance with the disclosed subject matter will be better appreciated with reference to the flow charts of FIGS. 8-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a method of facilitating computer application development 800 is illustrated. At reference numeral 810, a single-tier or tier-independent application is received, retrieved, identified, or otherwise obtained or acquired. At reference 820, an offlineable or occasionally connected distributed application is generated from the single-tier or tier-independent application by tier splitting computation and data across multiple tiers while preserving semantics of the single-tier application. Computations can be said to be forward split, wherein the computations and potentially associated reference data are pushed to an upstream tier. By contrast, data can be said to be reverse split, wherein a copy of upstream persistent data, including any modifications thereto, is projected back downstream to a client, for example by leveraging synchronization technology. Accordingly, application tiers include local copies of persistent data that allows offline work. Furthermore, such data also represents local caching and helps mitigate the effects of network latency. Generation of an offlineable distributed application can be accomplished automatically or semi-automatically. In accordance with one embodiment, generation can be governed by tier-splitting preferences or parameters specified in code annotations by a programmer, for instance.

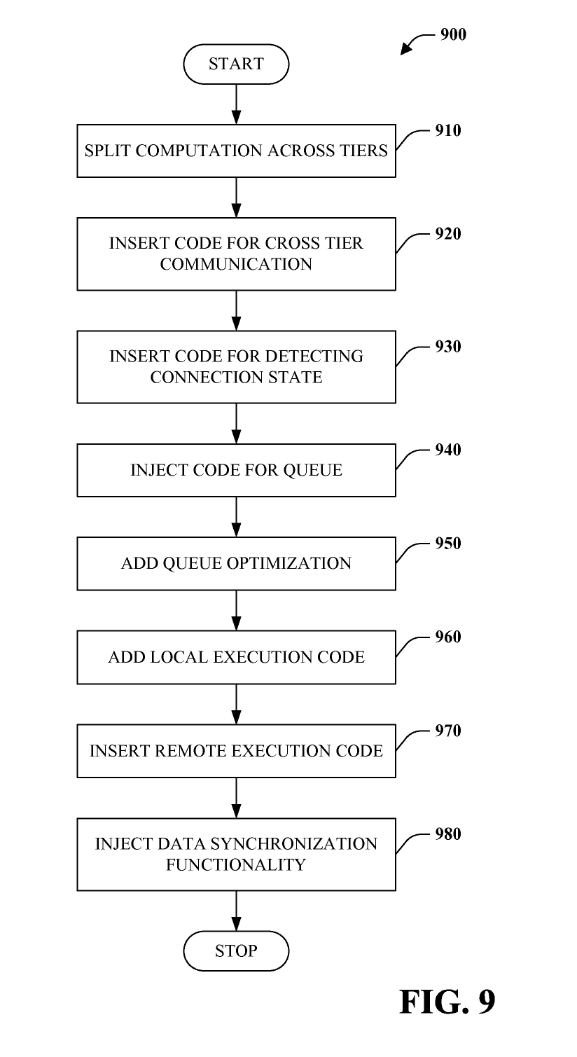

FIG. 9 depicts a method of generating an occasionally connected or offlineable distributed application 900. Among other things, code generation and/or transformation can be employed to produce a distributed application capable of operating in an occasionally connected environment while preserving semantics of an original application. At reference numeral 910, computations as well as any associated reference data are split across multiple tiers. At 920, code is inserted to enable cross-tier communication. For example, functionality for serializing, de-serializing, and transmitting content across a communication framework can be added at each tier. At numeral 930, code can be inserted for detecting a communication state between tiers such as online or offline.

Code for generating and interacting with a queue is injected at 940. For example, when a local computer requests that action be taken by a remote computer, the action can be added to the queue for subsequent transmission if cross-tier communication is unavailable. Alternatively, if cross-tier communication is available, the requested action can bypass the queue and be promptly transmitted to the remote computer. Subsequently, when online, queued actions can be transmitted subject to satisfaction of any optional policies or conditions (e.g., time, queue size, operation importance . . . ). Of course, depending upon implementation all requested actions can first be added to the queue and subsequently transmitted to another tier based on one or more conditions or policies to further leverage batch processing to mitigate effects of network latency and reduce bandwidth utilization, for instance. In other words, rather than immediately transmitting actions, they can be grouped and transmitted less frequently as a group to reduce network interaction time. Further, queued actions can be optimized or reduced such that less data is transmitted across the network.

At reference numeral 950, queue optimization code can be added. This code can reason about combinations of actions or operates in an attempt to reduce the number of actions and associated parameters and data that need to be transmitted to an upstream tier. Optimization can be accomplished by combining like actions to form a single action and/or removing redundant actions, among other things. For example, if one action adds an element and another action deletes that same element, both actions can be removed from the queue. Alternatively, if actions modify the same element then the actions can be combined. Of course, other such logic or mathematics of varying complexity can be implemented here to optimize a queue without affecting application consistence or correctness. Furthermore, queue optimization can comprise injecting code that translates or otherwise transforms one or more actions from a first form to a second semantically equivalent form to allow the one or more actions to execute locally when offline, for instance. By way of example, not limitation, code can be injected on a client and/or server to allow local offline computation without concern for compatibility issues.

At numeral 960, code is added for local offline execution. Although not limited thereto, in accordance with one aspect of the claimed subject matter, local offline computation can comprise performing abstract computations or in other words executing actions on an abstraction of one tier on another. For instance, sign computation (e.g., positive or negative) is an abstraction of multiplication. Thus, sign computation can be performed on a first tier while multiplication is performed on a second tier. In a two-tier scenario, abstract computations performed on a client can produce a subset of effects produced by computations performed on a server. By confining computation to abstract computations and/or a subset of operations, work can be performed offline on one tier while overall application consistency can be ensured across tiers. In accordance with one embodiment, such abstract computations can be identified during tier splitting and execution initiated where appropriate when cross-tier communication is unavailable.

Code is inserted at 970 to enable remote computation execution. A local tier service or the like can receive a collection of actions requested by another tier and perform or ensure performance thereof, for instance via scheduling, with respect to the local tier computations or code. For example, where a client flushes its queue to a server, computation calls are provided to the server for execution, wherein the server represents a local tier and the client represents another tier.

At reference numeral 980, data synchronization functionality is inserted with respect to multi-tier persistent data. Data synchronization projects upstream data including changes made thereto back downstream. In accordance with one embodiment of the claimed subject matter, upstream effects can be a superset of any downstream offline computation effects. Accordingly, data need only be projected one way from the downstream store to the upstream store, for example. Of course, data synchronization functionality be inserted to enable synchronized from a client upstream to a server or between a client and server, for instance.

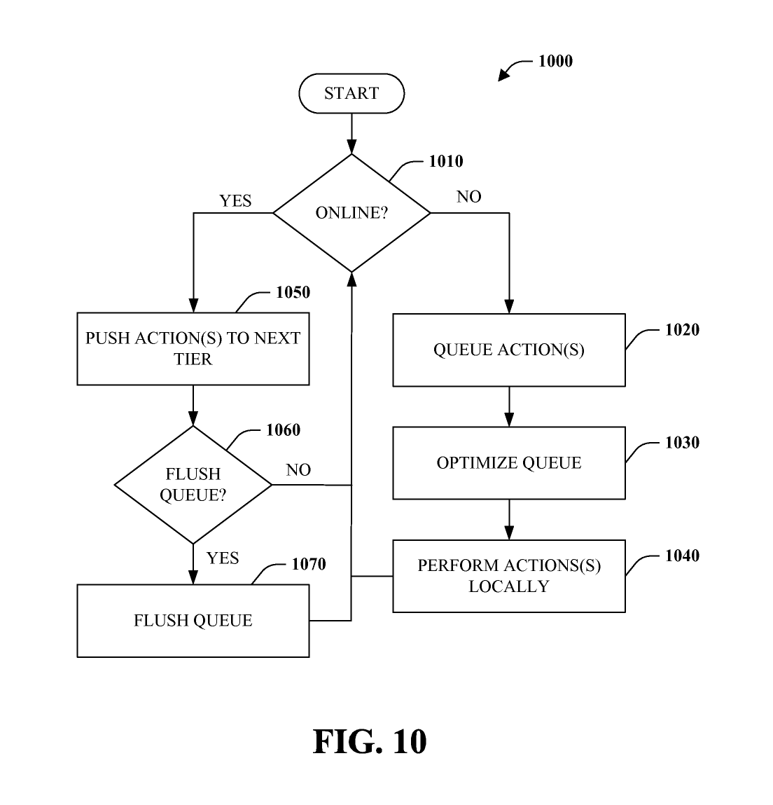

FIG. 10 depicts a method of operation on a tier 1000, such as a client in a two-tier architecture. At reference numeral 1010, a determination is made regarding the communication state of tiers. If tiers are not online, or in other words are offline, meaning cross-tier communication is not possible, the method continues at 1020 where any actions to be executed on another tier are placed in a queue or other data structure. At 1030, the queue can be optimized by combining actions and removing redundant actions, among other things. At numeral 1040, actions can be performed locally while offline. In accordance with an aspect of the claimed subject matter, the actions performed can be confined to abstract computations. A subset of actions and changes to data can be performed locally while a superset of actions can be performed on another tier. While offline, the method can continue to execute actions specified and described with respect to numerals 1020-1040.

If at numeral 1010, it is determined that the state is online, the process can continue at 1050. If any actions needed to be performed on another tier while online, at 1050, those actions are communicated to that tier. At reference 1060, a determination can be made concerning whether a queue should be flushed to another tier. Various factors can be taken into account to determine or infer whether the queue should be flushed including but not limited to time since it was last flushed, size or length of the queue, action priority, tier request, and/or external factors or context such as current network traffic. If it is determined that the queue should be flushed at 1060, then it is flushed at 1070. The method can continue to loop through actions 1050, 1060 and potentially 1070 until a state change occurs.

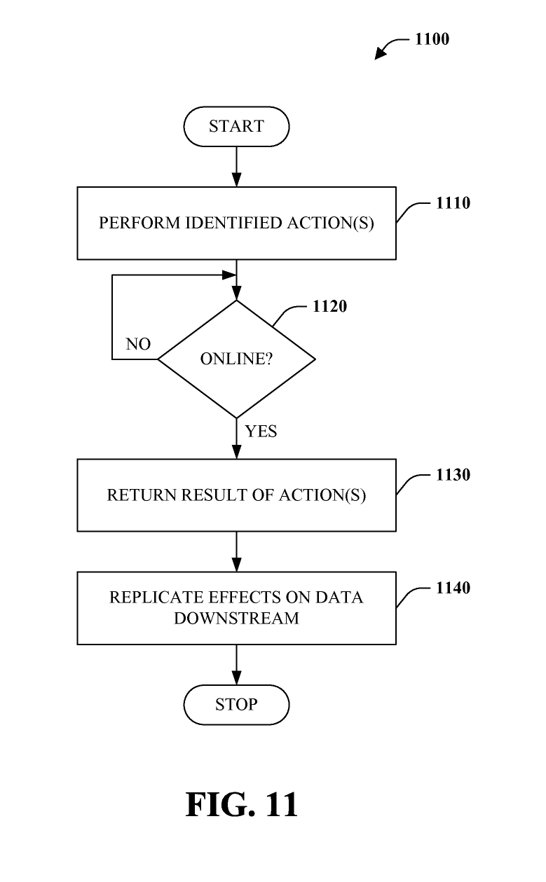

FIG. 11 is a flow chart diagram of a method 1100 of operation on a tier 1100, such as a server in a two-tier architecture. At reference numeral 1110, received, retrieved or otherwise identified actions are executed. For example, a downstream tier can communicate actions to perform which can then be executed as requested. At 1120, a determination is made as to whether tier connectivity is in an online or offline state. If offline (“NO”), the method loops at 1120. If online (“YES”), the method continues at 1130 where one or more results associated with particular actions are returned. At reference numeral 1140, effects of one or more actions on data are replicated downstream. In one instance, replication can form part of a synchronization process between tier data stores.

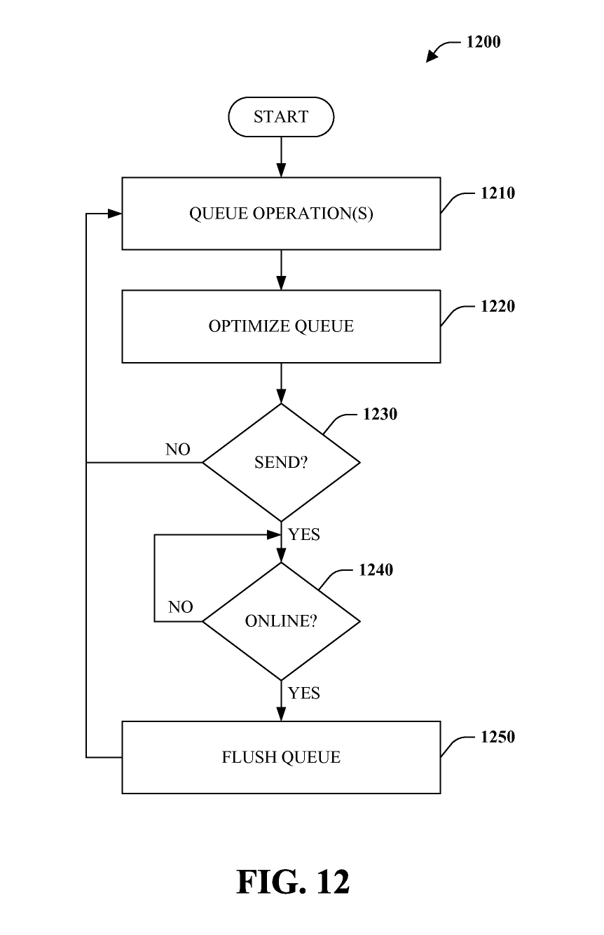

FIG. 12 depicts a method of operation on a tier 1200, such as a client in a two-tier architecture. At reference 1210, actions (e.g., CRUD operations) as well as associated parameters designated for execution on an upstream tier, for example, are added to a queue. The queue is optimized, at 1220, to reduce the number of operations that need to be transmitted and ultimately executed on another tier for instance by at least combining actions and removing redundant actions. At numeral 1230, a determination is made as to whether queued actions should be sent, for example based on one or more policies or conditions. Stated differently, the determination 1230 concerns whether or not contents of a queue should be transferred to a server, for instance. If actions should not be sent (“NO”), then the method loops back to 1210 where more actions are queued. If the actions should be sent (“YES”), a determination is made at 1240 concerning whether connectivity state with a tier for which the operations are to be sent is online or offline. If the connectivity state is not online but rather is offline (“NO”), the method continues to loop at 1240. If the state is online (“YES”), the method continues at 1250 where the queue content is flushed to another tier. The method then returns back to 1210. Since communication can be expensive in terms of time and use of network bandwidth, substantially all operations can be queued to enable batch processing. Furthermore, queue optimization may be able to reduce the number of operations that need to be sent and executed, which might not otherwise be possible if some operations bypass the queue and are sent immediately.

As used herein, the terms “component,” “system” and forms thereof intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

The terms “online” and “offline” generally pertain to cross-tier communication state. A distributed application is referred to as online when cross-tier communication is available. In other words, a first tier is able to communicate with a second tier in a two-tier architecture. By contrast, a distributed application is referred to as offline when cross-tier communication is unavailable. Stated differently, in a two-tier architecture, a first tier and second tier are offline when they are unable to communicate regardless of local network connectivity.

The word “offlineable,” as used herein, generally refers to an application's ability to perform work offline even though online connectivity is typically employed and may even be required at some point. Stated differently, an offlineable application can operate in an occasionally connected environment wherein the connectivity state can be online or offline at any given time. By way of example and not limitation, an application can be offline when a network such as the Internet, Wide Area Network (WAN), and/or Local Area Network (LAN) is unavailable.

“Persistent data” is intended to refer to data stored on a non-volatile medium that exists across application sessions. In other words, the persistent data survives application startup and termination. By contrast, “transient data,” often saved on a volatile medium such as memory, is created within or during an application session and is discarded at the end of the session. Similarly, the term “persist,” or various forms verb forms thereof, is intended to refer to storing data in a persistent form or as persistent data.

The words “upstream” and “downstream” are computer-networking terms that generally describe movement of network traffic (e.g., data) relative to a client or user device perspective. Upstream generally refers to sending or in other words movement of network traffic away from a client and to or toward a server, for example. By contrast, downstream refers to receiving or in other words movement of network data to or toward a client, for instance from a server. By way of example and not limitation, sending an e-mail generates upstream network traffic to a mail server while receiving email produces downstream network traffic from the mail server. Of course, the terms client and server as used above are simply terms of convenience to aid understanding and are not meant to indicate or in any way suggest requirement of a client-server relationship.

The term “cloud” is intended to refer to a communication network such as the Internet and underlying network infrastructure. Cloud computing generally pertains to Internet or cloud based applications or services including without limitation software as a service (SaaS), utility computing, web services, platform as a service (PaaS), and service commerce. Although not limited thereto, typically cloud services are available to clients via a web browser and network connection while the services are hosted on one or more Internet accessible servers.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

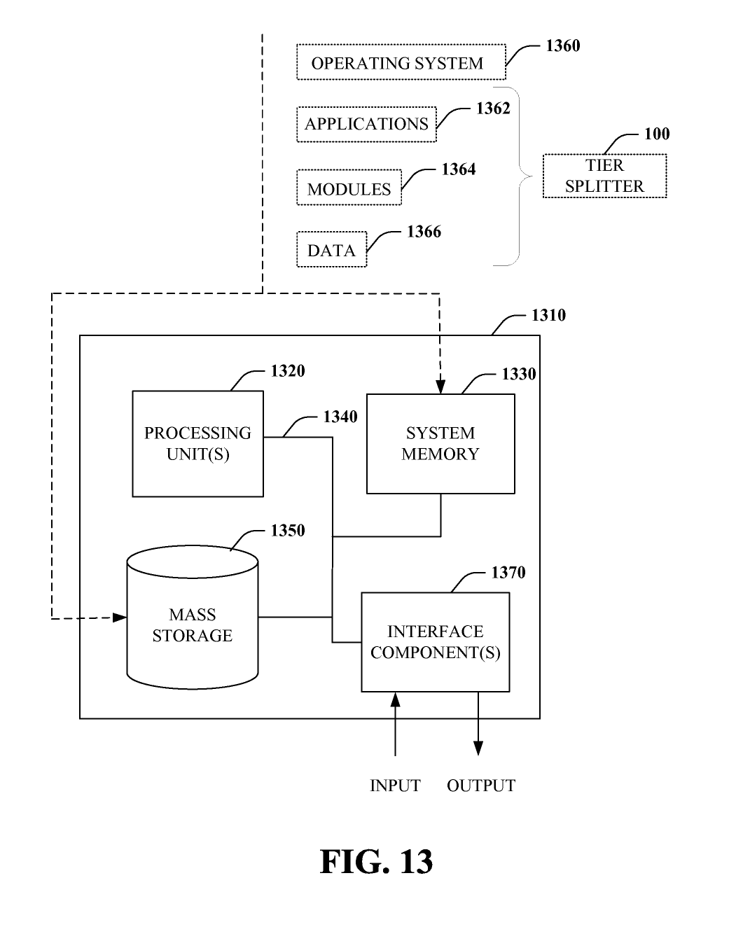

In order to provide a context for the claimed subject matter, FIG. 13 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 13, illustrated is an example computer or computing device 1310 (e.g., desktop, laptop, server, hand-held, programmable consumer or industrial electronics, set-top box, game system . . . ). The computer 1310 includes one or more processing units or processors 1320, system memory 1330, system bus 1340, mass storage 1350, and one or more interface components 1360. The system bus 1340 communicatively couples at least the above system components. However, it is to be appreciated that in its simplest form the computer 1310 can include one or more processors 1320 coupled to memory 1330 that execute various computer executable actions, instructions, and or components.

The processing unit 1320 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processing unit 1320 may also be implemented as a combination of computing devices, for example a combination of a DSP and a microprocessor, a plurality of microprocessors, multi-core processors, one or more microprocessors in conjunction with a DSP core, or any other such configuration.

The computer 1310 can include or otherwise interact with a variety of computer-readable media to facilitate control of the computer 1310 to implement one or more aspects of the claimed subject matter. The computer-readable media can be any available media that can be accessed by the computer 1310 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1310.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1330 and mass storage 1350 are examples of computer-readable storage media. Depending on the exact configuration and type of computing device, system memory 1330 may be volatile (e.g., RAM), non-volatile (e.g., ROM, flash memory . . . ) or some combination of the two. By way of example, the basic input/output system (BIOS), including basic routines to transfer information between elements within the computer 1310, such as during start-up, can be stored in nonvolatile memory, while volatile memory can act as external cache memory to facilitate processing by the processing unit 1320, among other things.

Mass storage 1350 includes removable/non-removable, volatile/non-volatile computer storage media for storage of large amounts of data relative to the system memory 1330. For example, mass storage 1350 includes, but is not limited to, one or more devices such as a magnetic or optical disk drive, floppy disk drive, flash memory, solid-state drive, or memory stick.

System memory 1330 and mass storage 1350 can include or have stored therein operating system 1360, one or more applications 1362, one or more program modules 1364, and data 1366. The operating system 1360 acts to control and allocate resources of the computing device 1310. Applications 1362 include one or both of system and application software and can leverage management of resources by operating system 1360 through program modules 1364 and data 1366 stored in system memory 1330 and/or mass storage 1350 to perform one or more actions. Accordingly, applications 1362 can turn a general-purpose computing device 1310 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the tier-splitter system 100 can be an application 1362 or part of an application 1362 and include one or more modules 1364 and data 1366 stored in memory and/or mass storage 1450 whose functionality can be realized when executed by one or more processors 1320, as shown. Furthermore, the compiler 610 or post compiler 710 including the tier splitter system 100 can similarly be an application 1362. As well, applications 1362 can comprise one or more offlineable distributed applications including cloud based versions thereof produced by or with aid from the tier-splitter system 100 as described herein.

The computer 1310 also includes one or more interface components 1370 that are communicatively coupled to the bus 1340 and facilitate interaction with the computer 1310. By way of example, the interface component 1370 can be a port (e.g., serial, parallel, PCMCIA, USB, FireWire . . . ) or an interface card (e.g., sound, video . . . ) or the like. In one example implementation, the interface component 1370 can be embodied as a user input/output interface to enable a user to enter commands and information into the computer 1310 through one or more input devices (e.g., pointing device such as a mouse, trackball, stylus, touch pad, keyboard, microphone, joystick, game pad, satellite dish, scanner, camera, other computer . . . ). In another example implementation, the interface component 1370 can be embodied as an output peripheral interface to supply output to displays (e.g., CRT, LCD, plasma . . . ), speakers, printers, and/or other computers, among other things. Still further yet, the interface component 1370 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system that facilitates development of occasionally connected distributed computer applications, comprising:
a processor coupled to a memory, the processor executes the following computer-executable components stored in the memory:
a first component configured to split one or more computations specified with respect to a single-tier application across a first tier and a second tier; and
a second component configured to inject code that when executed causes persistent data on the second tier and changes thereto that result from execution of one or more second-tier computations to be replicated to the first tier.

2. The system of claim 1, further comprising a third component configured to inject code that when executed causes one or more actions designated for second tier execution by way of computation invocation to be stored on the first tier when cross-tier communication is unavailable and transmission of the one or more actions to the second tier to be initiated when cross-tier communication is available.

3. The system of claim 2, the one or more actions correspond to create, read, update, or delete (CRUD) operations, and the persistent data is stored in CRUD-enabled data structures.

4. The system of claim 2, the second tier prompts transmission of the one or more actions to the second tier.

5. The system of claim 2, further comprising a fourth component configured to inject code that when executed causes at least a subset of the actions to be at least one of combined or, when redundant, removed to optimize stored actions when cross-tier communication is unavailable.

6. The system of claim 2, further comprising a fourth component configured to inject code that when executed causes one or more abstract computations to be executed on the first tier when cross-tier communication is unavailable.

7. The system of claim 1, further comprising a third component configured to inject code that when executed causes one or more actions designated for execution by the second tier by way of computation invocation to be stored on the first tier when cross-tier communication is available and transmission of the actions to the second tier to be initiated upon satisfaction of one or more predetermined conditions.

8. The system of claim 1, the second component is configured to inject code that when executed causes a data synchronization mechanism to be invoked to synchronize the persistent data between the first tier and the second tier.

9. The system of claim 1, further comprising a third component configured to inject code that when executed causes one or more actions designated for second-tier execution to be translated from a first form to a second semantically equivalent form to enable first-tier execution when cross-tier communication is unavailable.

10. The system of claim 1, the first component and second component are integrated within a compiler.

11. A method of aiding distributed program development, comprising:
employing at least one processor to execute computer-executable instructions stored in memory to perform the following acts:
identifying a single-tier application; and
generating an offlineable distributed application from the single-tier application while preserving single-tier application semantics by splitting computation and persistent data across multiple tiers.

12. The method of claim 11, further comprising generating code that maintains a queue of create, read, update, and/or delete (CRUD) operations for execution on a first tier when offline.

13. The method of claim 12, further comprising injecting code that optimizes the queue by combining two or more of the operations and/or removing redundant operations.

14. The method of claim 12, further comprising inserting code to push queued operations to a second tier upon request of the second tier.

15. The method of claim 11, further comprising generating code that pushes create, read, update, and/or delete (CRUD) operations to a second tier when cross-tier communication is available.

16. The method of claim 11, further comprising injecting code that inserts create, read, update, and/or delete (CRUD) operations into a queue when cross-tier communication is available and pushes queued operations from a first tier to a second tier upon satisfaction of at least one predetermined condition.

17. The method of claim 11, further comprising employing a synchronization framework to project data and updates to data at least from a first tier to a second tier.

18. A method of facilitating generation of an occasionally connected distributed application, comprising:
employing at least one processor to execute computer-executable instructions stored in memory to perform the following acts:
tier splitting one or more computations of a single-tier application across a client and server while preserving single-tier semantics; and
leveraging data synchronization to replicate on the client persistent server data and effects of one or more computations executed on the data by the server.

19. The method of claim 18, further comprising:
injecting code on the client that inserts actions for server execution by way of computation invocation in a client-side queue when cross-tier communication is unavailable;
inserting code that optimizes the queue by combining two or more of the actions and/or deleting redundant actions; and
generating code that initiates transmission of the actions in the queue to the server for execution when cross-tier communication is available.

20. The method of claim 19, further comprising injecting code that enables client execution of abstract computations when cross-tier communication is unavailable.
